(19) United States
(12) Patent Application Publication
(10) Pub. No.: US 2017/0090392 A1
(43) Pub. Date: Mar. 30, 2017

(54) DRIVE TRANSMISSION MECHANISM AND IMAGE FORMING APPARATUS PROVIDED WITH THE SAME

(71) Applicant: KYOCERA Document Solutions Inc., Osaka (JP)

(72) Inventor: Yuki TAMURA, Osaka (JP)

(73) Assignee: KYOCERA Document Solutions Inc., Osaka (JP)

(21) Appl. No.: 15/254,785

(22) Filed: Sep. 1, 2016

(30) Foreign Application Priority Data
Sep. 29, 2015 (JP) 2015-191219

(51) Int. Cl. G03G 15/00; F16H 1/20

(52) U.S. Cl. CPC G03G 15/757; F16H 1/20

(57) ABSTRACT

A drive transmission mechanism of the present disclosure is provided with a two-stage gear, an upstream-side gear, and first and second downstream-side gears. The two-stage gear includes a large diameter portion and a small diameter portion. The upstream-side gear transmits a rotational drive force to the large diameter portion. To each of the first and second downstream-side gears, a rotational drive force is transmitted from the small diameter portion. The small diameter portion has a first engagement region that engages with the first downstream-side gear and a second engagement region that engages with the second downstream-side gear. In an extending direction of a rotation axis of the two-stage gear, the first engagement region and the second engagement region are disposed so as not to overlap each other.

### INCORPORATION BY REFERENCE

This application is based upon and claims the benefit of priority from the corresponding Japanese Patent Application No. 2015-191219 filed on Sep. 29, 2015, the entire contents of which are incorporated herein by reference.

### BACKGROUND

The present disclosure relates generally to a drive transmission mechanism and an image forming apparatus provided with the same, and relates particularly to a drive transmission mechanism including two gears to each of which a rotational drive force is transmitted from a two-stage gear and an image forming apparatus provided with the same.

Conventionally, in an image forming apparatus such as a copy machine, a printer, or a facsimile, various types of rotary members are used in units including a drum unit, a developing unit, a fixing unit, a conveyance unit, and so on. In order for such rotary members to be rotated, it is required that a drive force be transmitted from a drive source such as a drive motor to the units, and to that end, a plurality of gears are used as a drive transmission mechanism. As each of such gears, a resinous gear is often used from the viewpoints such as that it is less costly, that it causes less noise, and that it is lightweight.

Furthermore, conventionally, as a structure for realizing miniaturization of an image forming apparatus, there is known a structure in which a drive transmission train for transmitting a rotational drive force to a plurality of units is partially common to the plurality of units.

### SUMMARY

A drive transmission mechanism according to a first aspect of the present disclosure is provided with a two-stage gear, an upstream-side gear, and first and second downstream-side gears. The two-stage gear includes a large diameter portion and a small diameter portion that has an outer diameter smaller than that of the large diameter portion. The upstream-side gear is disposed on an upstream side in a rotational drive force transmission direction with respect to the two-stage gear and transmits a rotational drive force to the large diameter portion. The first and second downstream-side gears are disposed on a downstream side in the rotational drive force transmission direction with respect to the two-stage gear, and a rotational drive force is transmitted thereto from the small diameter portion. The small diameter portion has a first engagement region that engages with the first downstream-side gear and a second engagement region that engages with the second downstream-side gear. In an extending direction of a rotation axis of the two-stage gear, the first engagement region and the second engagement region are disposed so as not to overlap each other.

Still other objects of the present disclosure and specific advantages provided by the present disclosure will be made further apparent from the following description of an embodiment.

### BRIEF DESCRIPTION OF THE DRAWINGS

FIG. 1 is a sectional view schematically showing a structure of an image forming apparatus provided with a drive transmission mechanism of one embodiment of the present disclosure.

FIG. 2 is a side view showing a structure of a periphery of the drive transmission mechanism of one embodiment of the present disclosure.

FIG. 3 is a perspective view showing a structure of a periphery of a two-stage gear of the drive transmission mechanism of one embodiment of the present disclosure.

FIG. 4 is a sectional view showing a structure of the two-stage gear of the drive transmission mechanism of one embodiment of the present disclosure.

FIG. 5 is a view seen in a direction of an arrow A in FIG. 3.

FIG. 6 is a view seen in a direction of an arrow B in FIG. 3.

### DETAILED DESCRIPTION

The following describes an embodiment of the present disclosure with reference to the appended drawings.

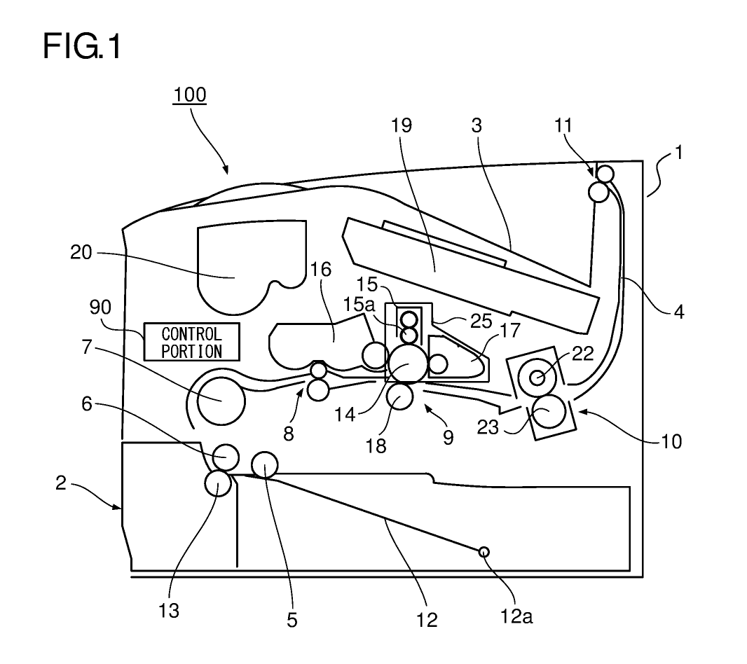

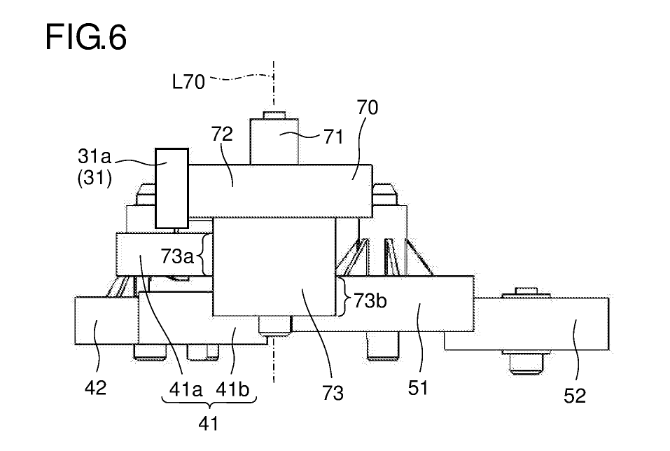

With reference to FIG. 1 to FIG. 6, a description is given of an image forming apparatus 100 provided with a drive transmission mechanism of one embodiment of the present disclosure. As shown in FIG. 1, the image forming apparatus 100 (which is herein a monochrome printer) is provided with a paper feed cassette 2 to house therein paper sheets (recording media) stacked at a lower portion in an apparatus main body 1. In FIG. 1, the image forming apparatus 100 is shown so that a front side thereof is on a left side. Above the paper feed cassette 2, a paper sheet conveyance path 4 is formed that extends substantially horizontally from a front of the apparatus main body 1 to a back thereof and further extends upward to reach a paper ejection portion 3 that is formed on an upper surface of the apparatus main body 1. Along the paper sheet conveyance path 4, in order from an upstream side, a pick-up roller 5, a feed roller 6, an intermediate conveyance roller 7, a registration roller pair 8, an image forming portion 9, a fixing unit 10, and an ejection roller pair 11 are disposed. Moreover, inside the image forming apparatus 100, a control portion 90 is disposed that controls operations of the above-described various rollers, the image forming portion 9, the fixing unit 10, and so on.

The paper feed cassette 2 is provided with a paper sheet stacking plate 12 that is supported so as to be circularly movable with respect to the paper feed cassette 2 about a circular movement fulcrum 12a that is provided at a back end portion in a paper sheet conveyance direction, and paper sheets stacked on the paper sheet stacking plate 12 are pressed by the pick-up roller 5. Furthermore, on a front side of the paper feed cassette 2, a retard roller 13 is arranged so as to be in press-contact with the feed roller 6. The retard roller 13 is configured so that, in a case where a plurality of paper sheets are fed at the same time by the pick-up roller 5, the paper sheets are separated from each other by the feed roller 6 and the retard roller 13 in such a manner that only an uppermost one of the paper sheets is conveyed.

Then, each of the paper sheets separated from each other by the feed roller 6 and the retard roller 13 is changed in its conveyance direction by the intermediate conveyance roller 7 to be directed to the back of the apparatus and is conveyed to the registration roller pair 8 from which the each of the paper sheets is supplied to the image forming portion 9 at timing adjusted by the registration roller pair 8.

The image forming portion 9 is to form a prescribed toner image on a paper sheet by an electrophotographic process and is composed of a photosensitive drum 14 as an image carrier that is axially supported so as to be rotatable in a counterclockwise direction in FIG. 1, a charging device 15, a developing unit 16, and a cleaning device 17 that are disposed around the photosensitive drum 14, a transfer roller (transfer member) 18 that is disposed so as to be opposed to the photosensitive drum 14 with the paper sheet conveyance path 4 interposed therebetween, an exposure unit (LSU) 19 that is disposed above the photosensitive drum 14, and a static eliminating device (not shown). Above the developing unit 16, a toner container 20 is disposed that replenishes the developing unit 16 with toner. The photosensitive drum 14, the charging device 15, and the cleaning device 17 are formed integrally with one another and constitute a drum unit (a driving unit, an image carrier unit) 25.

The charging device 15 is provided with a charging roller 15a to which an unshown power source is connected, and the charging roller 15a is disposed so as to be in contact with the photosensitive drum 14. Further, when the photosensitive drum 14 rotates, while being in contact with a surface of the photosensitive drum 14, the charging roller 15a rotates following the rotation of the photosensitive drum 14, at which time, a prescribed voltage is applied to the charging roller 15a so that the surface of the photosensitive drum 14 is uniformly charged.

Subsequently, by a laser beam from the exposure unit (LSU) 19, an electrostatic latent image based on inputted image data is formed on the photosensitive drum 14, and by the developing unit 16, toner is made to adhere to the electrostatic latent image to form a toner image on the surface of the photosensitive drum 14. By the transfer roller 18, the toner image formed on the surface of the photosensitive drum 14 is transferred to a paper sheet supplied to a transfer position that is formed at a nip portion between the photosensitive drum 14 and the transfer roller 18.

The paper sheet to which the toner image has been transferred is separated from the photosensitive drum 14 and is conveyed toward the fixing unit 10. The fixing unit 10 is disposed on a downstream side of the image forming portion 9 with respect to the paper sheet conveyance direction, and the paper sheet to which the toner image has been transferred at the image forming portion 9 is heated and pressed by a heating roller 22 and a pressing roller 23 that is press-contacted by the heating roller 22, respectively, which are provided in the fixing unit 10, so that the toner image transferred to the paper sheet is fixed. The fixing unit 10 has a load torque larger than that of the drum unit 25. Compared with the fixing unit 10, the drum unit 25 is required to achieve rotation with less rotation fluctuation and thus with higher accuracy.

Then, the paper sheet that has been subjected to an image forming process and a fixing process at the image forming portion 9 and the fixing unit 10, respectively, is ejected to the paper ejection portion 3 by the ejection roller pair 11. Meanwhile, toner remaining on the surface of the photosensitive drum 14 after the transfer is removed by the cleaning device 17. Then, the photosensitive drum 14 is charged again by the charging device 15, after which subsequent image formation is performed in a similar manner.

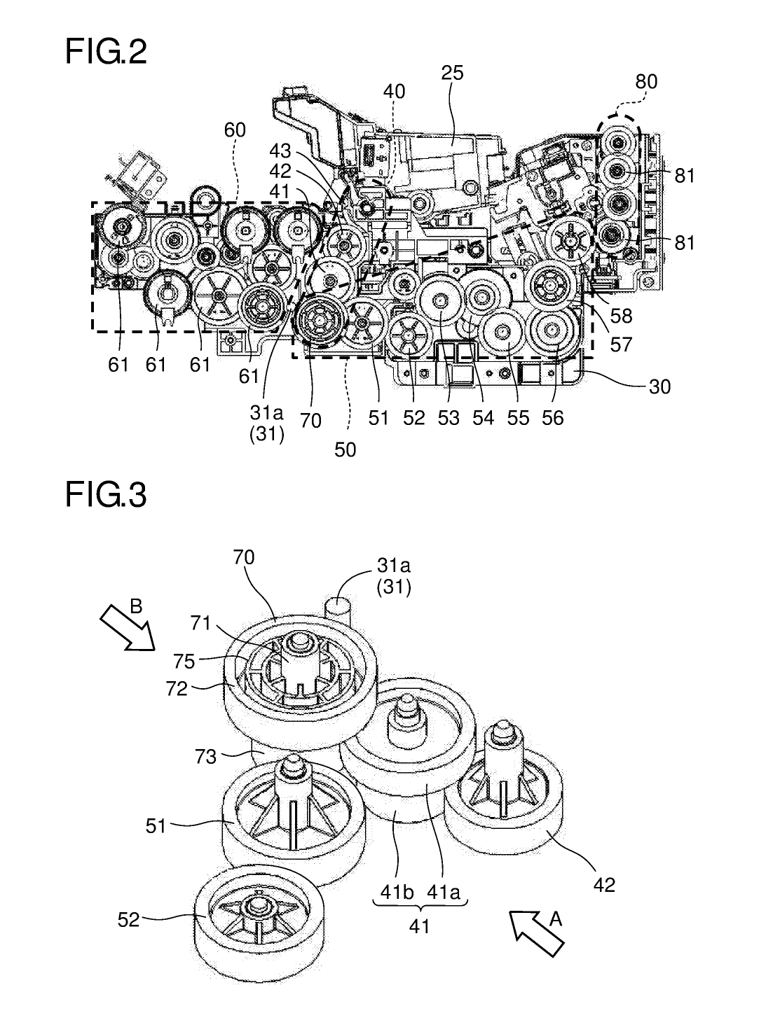

As shown in FIG. 2, on one side inside the apparatus main body 1 (a forward side with respect to a paper plane of FIG. 1), a frame 30 is disposed to which a multitude of gears are rotatably mounted. In the frame 30, there are provided a drive transmission train 40 that transmits a rotational drive force to the drum unit 25, a drive transmission train 50 that transmits a rotational drive force to the fixing unit 10, and a drive transmission train 60 that transmits a rotational drive force to the pick-up roller 5, the feed roller 6, the intermediate conveyance roller 7, the registration roller pair 8, the developing unit 16, and so on. Furthermore, on an outer side of the frame 30 (a forward side with respect to a paper plane of FIG. 2), there is provided a drive motor (drive portion) 31 having a gear portion 31a (upstream-side gear) that transmits a rotational drive force to the drive transmission trains 40, 50, and 60. The gear portion 31a and the drive transmission trains 40 and 50 constitute a drive transmission mechanism of the present disclosure.

The drive transmission train 40 includes a two-stage gear 70 as a shared gear that is used in common with the drive transmission train 50 and gears 41, 42, and 43. Further, a rotational drive force transmitted from the drive motor 31 to the two-stage gear 70 is transmitted to the drum unit 25 via the gears 41, 42, and 43 that engage sequentially with each other. The gear 41 is one example of a first downstream-side gear of the present disclosure.

The drive transmission train 50 includes the two-stage gear 70 and gears 51 to 58. Further, a rotational drive force transmitted from the drive motor 31 to the two-stage gear 70 is transmitted to the fixing unit 10 via the gears 51, 52, 53, 54, 55, 56, 57, and 58 that engage sequentially with each other. The gear 51 is one example of a second downstream-side gear of the present disclosure. Furthermore, a drive transmission train 80 including a plurality of gears 81, which transmits a rotational drive force to the ejection roller pair 11, is linked to the gear 58.

The drive transmission train 60 includes a plurality of gears 61, and via the plurality of gears 61, a rotational drive force from the drive motor 31 is transmitted to the pick-up roller 5, the feed roller 6, the intermediate conveyance roller 7, the registration roller pair 8, the developing unit 16, and so on.

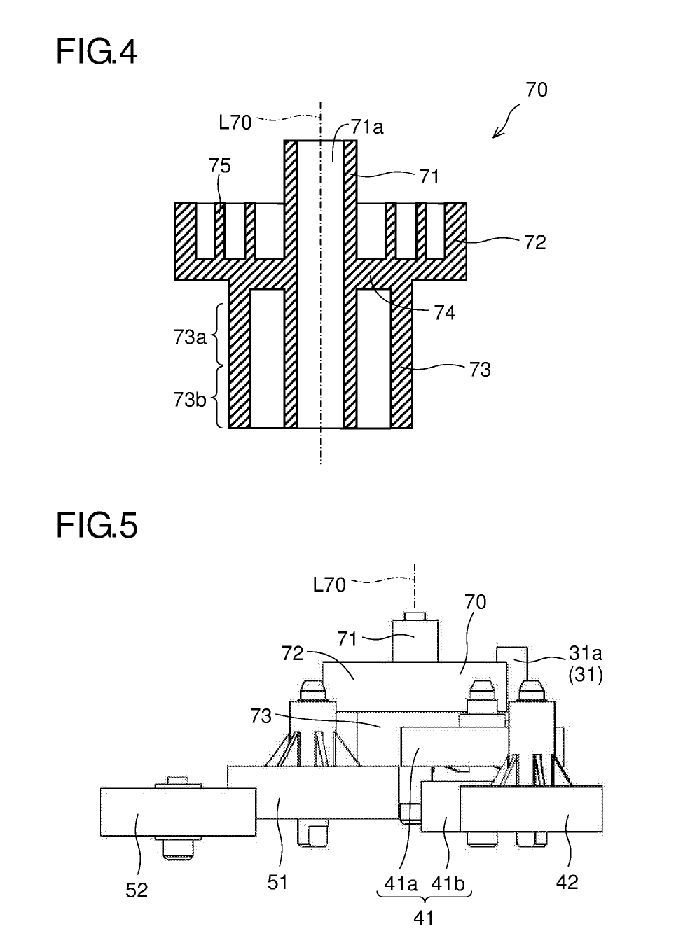

The two-stage gear 70 is made of resin and is formed by injection molding using a mold. As shown in FIG. 3 and FIG. 4, the two-stage gear 70 includes a cylindrical boss portion 71 that is formed at a center portion thereof, a large diameter portion 72 that protrudes outward in a diameter direction of the boss portion 71, and a small diameter portion 73 that protrudes outward in the diameter direction of the boss portion 71 and has an outer diameter smaller than that of the large diameter portion 72.

At a center of the boss portion 71, a through hole 71 a is formed into which a shaft portion is inserted. At a boundary area between the large diameter portion 72 and the small diameter portion 73, a disc-shaped web portion 74 is formed. At an outer periphery portion of the large diameter portion 72, a tooth portion is formed that engages with the gear portion 31a of the drive motor 31, and at an outer periphery portion of the small diameter portion 73, a tooth portion is formed that engages with the gear 41 of the drive transmission train 40 and the gear 51 of the drive transmission train 50.

Between the tooth portion of the small diameter portion 73 and the boss portion 71, a space is formed for achieving weight reduction. Also between the tooth portion of the large diameter portion 72 and the boss portion 71, a space is formed for achieving weight reduction, and a rib 75 for reinforcement is formed in this space.

Furthermore, the gear 41 of the drive transmission train 40 includes a large diameter portion 41a that engages with the two-stage gear 70 and a small diameter portion 41b that engages with the gear 42.

Here, as shown in FIG. 4 to FIG. 6, the small diameter portion 73 of the two-stage gear 70 has a first engagement region 73a that engages with the large diameter portion 41a of the gear 41 and a second engagement region 73b that engages with the gear 51. In an extending direction of a rotation axis L70 of the gear 70, a tooth portion of the large diameter portion 41a of the gear 41 is disposed so as not to overlap a tooth portion of the gear 51. Thus, in the extending direction of the rotation axis L70 of the gear 70, the first engagement region 73a and the second engagement region 73b do not overlap each other.

In this embodiment, as described above, in the extending direction of the rotation axis L70 of the two-stage gear 70, the first engagement region 73a and the second engagement region 73b of the small diameter portion 73 of the two-stage gear 70 are disposed so as not to overlap each other. Thus, even in a case where, for example, the second engagement region 73b that engages with the gear 51 is worn out, since the gear 41 that transmits a rotational drive force to the drum unit 25, which is required to achieve high rotation accuracy, does not engage with the second engagement region 73b, a decrease in rotation accuracy of the gear 41 can be suppressed.

Furthermore, with the first engagement region 73a and the second engagement region 73b disposed so as not to overlap each other, compared with a case where the first engagement region 73a and the second engagement region 73b are disposed so as to overlap each other, a wear rate of a tooth surface of the small diameter portion 73 can be reduced. Thus, a decrease in rotation accuracy can be further suppressed.

Furthermore, as described above, compared with the gear 51, the gear 41 is configured to transmit a rotational drive force toward the drum unit 25, which is required to achieve rotation with higher accuracy, and the first engagement region 73a that engages with the gear 41 is disposed on a large diameter portion 72 side with respect to the second engagement region 73b. Generally, it is likely that, due to an influence of resin contraction at the time of manufacturing, a resinous gear has dimensional accuracy decreasing with increasing proximity to an end portion thereof. That is, a middle portion of the gear 70 (an area of the small diameter portion 73 closer to the large diameter portion 72) is formed with relatively high dimensional accuracy. For this reason, the gear 41 that transmits a rotational drive force toward the drum unit 25, which is required to achieve rotation with high accuracy, is made to engage with the middle portion of the gear 70 (the area of the small diameter portion 73 closer to the large diameter portion 72), and thus a decrease in rotation accuracy of the gear 41 can be further suppressed.

The embodiment disclosed herein is to be construed in all respects as illustrative and not limiting. The scope of the present disclosure is indicated by the appended claims rather than by the foregoing description of the embodiment, and all changes that come within the meaning and range of equivalency of the claims are intended to be embraced therein.

While an example has been shown in which, for example, the present disclosure is applied to a monochrome printer, the present disclosure is not limited thereto. Needless to say, the present disclosure is applicable to various types of image forming apparatuses each provided with a drive transmission mechanism including two gears to each of which a rotational drive force is transmitted from a two-stage gear, such as a color printer, a monochrome copy machine, a color copy machine, a digital multi-functional peripheral, and a facsimile.

Furthermore, while the above-described embodiment has shown an example in which, compared with the gear 41, the gear 51 that transmits a rotational drive force toward the fixing unit 10, which has a large load torque, is made to engage with an area of the small diameter portion 73 distant from the large diameter portion 72, the present disclosure is not limited thereto, and a configuration also may be adopted in which, compared with the gear 41, the gear 51 is made to engage with the area of the small diameter portion 73 closer to the large diameter portion 72. That is, the second engagement region 73b that engages with the gear 51 that transmits a rotational drive force toward the fixing unit 10, which has a large load torque, may be disposed on the large diameter portion 72 side with respect to the first engagement region 73a.Since, as shown in FIG. 4, a clearance is formed between the small diameter portion 73 and the boss portion 71, when a load is applied to the small diameter portion 73, it is likely that the tooth surface of the small diameter portion 73 becomes distorted to a boss portion 71 side with increasing distance from the large diameter portion 72. For this reason, the gear 51 that transmits a rotational drive force toward the fixing unit 10, which has a relatively large load torque, is made to engage with the area of the small diameter portion 73 closer to the large diameter portion 72, in which case a distortion of the tooth surface of the small diameter portion 73 can be suppressed, and a decrease in rotation accuracy of the gear 51 can be suppressed.

Furthermore, while the above-described embodiment has shown an example in which, as the first downstream-side gear and the second downstream-side gear of the present disclosure, the gears 41 and 51 that transmit a rotational drive force toward the drum unit 25 and the fixing unit 10, respectively, are used, a gear that transmits a rotational drive force toward a developing unit, a conveyance unit including a plurality of conveyance rollers, or any other drive unit may be used as each of the first downstream-side gear and the second downstream-side gear.

What is claimed is:

1. A drive transmission mechanism, comprising:
a two-stage gear that includes a large diameter portion and a small diameter portion that has an outer diameter smaller than that of the large diameter portion;
an upstream-side gear that is disposed on an upstream side in a rotational drive force transmission direction with respect to the two-stage gear and transmits a rotational drive force to the large diameter portion; and
first and second downstream-side gears that are disposed on a downstream side in the rotational drive force transmission direction with respect to the two-stage gear and to which a rotational drive force is transmitted from the small diameter portion,
wherein
the small diameter portion has a first engagement region that engages with the first downstream-side gear and a second engagement region that engages with the second downstream-side gear, and
in an extending direction of a rotation axis of the two-stage gear, the first engagement region and the second engagement region are disposed so as not to overlap each other.

2. The drive transmission mechanism according to claim 1, wherein
compared with the first downstream-side gear, the second downstream-side gear is configured to transmit a rotational drive force toward a drive unit that has a larger load torque, and
the second engagement region is disposed on a side toward the large diameter portion with respect to the first engagement region.

3. The drive transmission mechanism according to claim 1, wherein
compared with the second downstream-side gear, the first downstream-side gear is configured to transmit a rotational drive force toward a drive unit that is required to achieve rotation with higher accuracy, and
the first engagement region is disposed on a side toward the large diameter portion with respect to the second engagement region.

4. An image forming apparatus comprising the drive transmission mechanism according to claim 1.

5. The image forming apparatus according to claim 4, further comprising:
an image carrier unit that includes an image carrier on which an electrostatic latent image is formed; and
a fixing unit that heats and presses a recording medium so that an unfixed toner image is fixed on the recording medium,
wherein the first downstream-side gear transmits a rotational drive force toward the image carrier unit, and
the second downstream-side gear transmits a rotational drive force toward the fixing unit.
